(19) United States
(12) Patent Application Publication
(10) Pub. No.: US 2005/0187818 A1
(43) Pub. Date: Aug. 25, 2005

(54) Computerized advertising offer exchange

(76) Inventors: David D. Zito, Pasadena, CA (US); Joseph Essas, Los Angeles, CA (US); Reza Ali Ghanbari, Wayzata, MN (US); Yusuf Cem Gomel, Pasadena, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/783,383

(22) Filed: Feb. 20, 2004

(51) Int. Cl. G06F 17/60

(52) U.S. Cl. 705/14

(57) ABSTRACT

In some embodiments, the present invention provides methods and systems for facilitating transactions between advertisers and advertisees for arranging for presentation of advertisements to users of computers or other computerized devices. Advertiser and advertisee offers, including user context conditions, are obtained. User context information is obtained, such as real-time or almost real-time information about an online user of an Internet site of the advertiser. If a match is determined between an advertiser offer, an advertisee offer, and a user context, arranging for presentation of an advertisement to the user is facilitated.

### RELATED APPLICATION

This application is related to U.S. Provisional Patent Application No. ______, Attorney Docket No. 5598/66 PROV, filed on even date herewith, and entitled, “Computer Advertising Offer Exchange,” which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates in general to computerized exchanges, and in particular to computerized systems and methods for facilitating advertising transactions.

User traffic on networked computer systems, such as the Internet, represents a huge and still growing channel for advertising, including promotion and facilitation of sales of products and services, including content. Such traffic includes not only users who conduct searches using, for example, Internet-based search portals, but also a huge quantity of users frequenting all manner of Internet sites and Web pages, including, for example, news sites, sports sites, directory sites, etc. As with all advertising, the efficiency and rate of success of Internet advertising is crucially tied to the relevance and appeal of particular advertisements to their particular user audience, or the degree to which the advertisement is well-targeted to its user audience. Advertisements that are not well-targeted or not targeted at all are likely to be unsuccessful or even completely ignored, especially as users, from experience, begin to anticipate the untargeted advertisements. For example, untargeted Web page banners are typically ignored by users. Conversely, advertisements that are keenly targeted to match the audience to which they are presented are much more likely to be noticed, considered, and acted upon.

Targeting of online advertisements through search engines has revolutionized the advertising industry by not only dramatically increasing the typical return on investment (ROI) for such advertisements but also by providing a complete and accurate system of analytics to evaluate the performance of advertisements from first contact to completion of a sale attributable to such advertisements. Yet even though search engine marketing has enabled one of the highest levels of ROI ever in advertising, it has so far been generally done on the basis of one variable: the search term or phrase entered by the user into the search engine. While the offline art of targeted advertising may consider multiple variables including age, gender, income, location, etc. of a user, search engine marketing has not yet become that sophisticated. Existing search engine marketplaces, for example, do not include expanded capabilities, such as sophisticated methods of matching advertisers and users that include the capability to go beyond simple matching of keywords to queries to consider multiple variables. Better-targeted Internet-based advertising, if efficiently available, could allow profitable exploitation of a huge and heretofore largely untapped audience. As the sophistication of the Internet increases, both resources and users are becoming more explicit in the methods and systems by which they manage themselves. This suggests a need for increased automation of information discovery, batching and delivery, including advertising content. Such well-targeted advertising could be made possible if Web-based advertisers were able to efficiently transact with advertisees to arrange for presentation of advertisements to user audiences that are well-suited to receive the advertisements. Advertisees can include, for example, owners or operators of media channels such as Web sites or Web pages through which, associated with which, or concurrently with use of which, advertisements can be presented, or content distributors.

Thus, there is a need for computerized systems and methods for facilitating matching techniques between advertisers and advertisees for arranging for presentation of advertisements to specifically targeted computer users.

### SUMMARY OF THE INVENTION

In some embodiments, the present invention provides computerized methods and systems for facilitating transactions between at least advertisers and advertisees for providing for presentation of advertisements to targeted computer users.

In some embodiments, the present invention provides a method to optimize the management of an online targeted advertising marketplace by increasing the efficiency and scale of the marketplace and it's subsidiary services and constituencies through the provision of systems and methods for the definition and matching of multiple variables for targeted advertising in real-time. In some embodiments, the invention provides an ability to match advertisements to users based upon multi-dimensional offers, not only increasing the targetability of the advertisements but also simultaneously increasing the relevance of a user's experience.

In some embodiments, the invention provides an environment or exchange incorporating many different marketplaces in which different types of advertising-related offers are marketed and matched. Real-time negotiation between advertisers and advertisees can be facilitated. Marketplaces can be real-time configurable or tunable by parties including an advertiser, an advertisee, or a marketplace operator using modular engines that can include matching engines, filter engines, ranking engines, and pricing engines. Universal offer collection and universal demand collection can be used to pool, annotate, and distribute offers appropriately among marketplaces. Advertiser and advertisee tools can be provided to assist in configuration of, or actually configure, offers as well as marketplaces, and to appropriately populate offer and demand pools associated with the universal offer and demand collection, according to information about or provided by the advertisers and advertisees and their offers.

In one embodiment, the invention provides, in a networked computer system, a computerized method for facilitating a transaction between at least an advertiser and an advertisee for arranging for presentation of an advertisement to at least one user of a computerized device. The method includes obtaining an advertiser offer including conditions including a first set of one or more user context conditions required by the advertiser for presentation of the advertisement to the user. The method further includes obtaining an advertisee offer including conditions including a second set of one or more user context conditions required by the advertisee for presentation of the advertisement to the user. The method further includes obtaining user context information including information relating to the first and second sets of user context conditions. The method further includes, using the advertiser offer conditions, the advertisee offer conditions, and the obtained user context information, determining whether a match exists between the advertiser offer, the advertises offer, and the user context. The method further includes, if the match exists, facilitating arranging for presentation of the advertisement to the user.

In another embodiment, the invention provides a system for facilitating a transaction between at least an advertiser and an advertisee for arranging for presentation of an advertisement to at least one user of a computerized device. The system includes means for obtaining an advertiser offer including conditions including a first set of one or more user context conditions required by the advertiser for presentation of the advertisement to the user. The system further includes means for obtaining an advertisee offer including conditions including a second set of one or more user context conditions required by the advertisee for presentation of the advertisement to the user. The system further includes means for obtaining user context information including information relating to the first and second sets of user context conditions. The system further includes means for using the advertiser offer conditions, the advertisee offer conditions, and the obtained user context information, determine whether a match exists between the advertiser offer, the advertisee offer, and the user context. The system further includes means for, if the match exists, facilitating arranging for presentation of the advertisement to the user.

In another embodiment, the invention provides a system for facilitating a transaction between at least an advertiser and an advertisee for arranging for presentation of an advertisement to at least one user of a computerized device. The system includes one or more offer exchange server computers connected to a network, and one or more offer exchange databases connected to the network and accessible by the one or more offer exchange server computers. The one or more offer exchange databases store information including an advertiser offer including conditions including a first set of one or more user context conditions required by the advertiser for presentation of the advertisement to the user. The one or more offer exchange databases further store an advertisee offer including conditions including a second set of one or more user context conditions required by the advertisee for presentation of the advertisement to the user. The one or more offer exchange databases further store user context information including information relating to the first and second sets of user context conditions. The one or more offer exchange server computers, using the advertiser offer conditions, the advertisee offer conditions, and the user context information, determine whether a match exists between the advertiser offer, the advertisee offer, and the user context. Furthermore, the one or more offer exchange server computers, if the match exists, facilitate arranging for presentation of the advertisement to the user.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a distributed computer system according to one embodiment of the invention;

FIG. 2 is a conceptual block diagram depicting offer configuration, according to one embodiment of the invention;

FIG. 3 is a conceptual block diagram depicting a method according to one embodiment of the invention;

FIG. 4 is a conceptual block diagram depicting a method according to another embodiment of the invention;

FIG. 5 is a flow diagram depicting a method according to one embodiment of the invention;

FIG. 6 is a flow diagram depicting a method according to another embodiment of the invention;

FIG. 7 is a flow diagram depicting a method according to another embodiment of the invention;

FIG. 8 is a conceptual block diagram depicting components of a multi-dimensional offer, according to one embodiment of the invention;

FIG. 9 is a conceptual block diagram depicting components of an offer exchange factory, according to one embodiment of the invention; and

FIG. 10 is a conceptual block diagram depicting multiple virtual marketplaces and an associated offer exchange engine.

### DETAILED DESCRIPTION OF THE PREFERRED EMBODIMENTS

In the following description of the preferred embodiments, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

Some embodiments of the present invention can utilize some aspects or elements described in U.S. Pat. No. 6,269,361, filed on May 28, 1999 and issued on Jul. 31, 2001, and commonly owned U.S. patent application Ser. No. 10/303,167 filed on Nov. 22, 2002, entitled, “ONLINE MEDIA EXCHANGE”, each of which is hereby incorporated herein by reference in their entirety.

In some embodiments, the present invention provides methods and systems for facilitating transactions between advertisers and advertisees for arranging for presentation of advertisements to users of computers or other computerized devices. Advertiser and advertisee offers, including user context conditions, are obtained. User context information is obtained, such as real-time or almost real-time information about an online user of an Internet site of the advertisee. If a match is determined between an advertiser offer, an advertisee offer, and a user context, arranging for presentation of an advertisement to the user is facilitated. Advertisements can promote, include an attempt to sell, or facilitate sales of, for example, products, services, or content. In some embodiments, advertisements can include metadata that can be used to facilitate matching as described herein.

In some embodiments, an offer exchange engine of a marketplace operator is used, the advertisees being affiliates of the marketplace operator. The offer exchange engine of the marketplace operator can allow efficient and effective offer communication, configuration, or selection by advertisers and advertisees. Furthermore, the offer exchange engine can be used to obtain user context information and match offers and user contexts. Offer conditions and obtained user context information can include multiple parameters or dimensions relating to various conditions including user characteristics or historical behavioral information about a user, pricing terms, content-related terms, temporal terms, media-related terms, and other types of terms. Furthermore, dimensions can be specified with varying degrees of resolution, which can allow more or less narrow targeting of users. In some embodiments, the roles and functions of a marketplace operator or of an offer exchange engine, as described further below, can be automated or partially automated, for example, through the use of artificial intelligence, neural networks, computerized scripts, or other techniques.

Matching of such offers and user context information helps enable effective targeting of particular advertisements to users that may be considered or demonstrated to be appropriate audiences for the advertisements. The targeted users are considered or determined to be particularly likely to notice the advertisement, to find it to be relevant, interesting, or suitable, or to be likely to be affected by or act on the advertisement, such as, for example, by clicking through to purchase products, services, or content. Additionally, in some embodiments, a database of information can be utilized by the offer exchange engine to generate pre-defined offers for selection by advertisers or advertisees. In some embodiments, the marketplace operator charges a fee to advertisers or advertisees for facilitating the transactions, or for services such as providing suggested pre-defined offers, or providing marketplaces, such as auctions, in such pre-defined offers.

Compared to the traditional pipeline of line ad creation, approval, matching and delivery, the present invention presents an infinitely more scalable method for matching large volumes of advertisements with large volumes and varieties of consumer traffic and thus increases the efficiency and responsiveness of the marketplace operator to both its advertisers and affiliate sources of consumer traffic. In some embodiments, besides enabling the use of multiple targeting and demographic data in the matching process, the present invention is also suitable for delivery of any kind of advertising, e.g. text, pictures, video, audio, device-driven, etc. to any kind of medium, e.g. PCs, hand-held or wireless devices, electronic billboards, elevators, cars, etc.

In some embodiments, beyond the improved scalability and efficiency in the marketplace's operation, the present system can also provide a dynamic, machine-learning intelligence layer that provides a method for continually optimizing the operation of the marketplace over time. By aggregating and analyzing the sum of user's data across all contexts, the system greatly improves the ability of the marketplace operator to infer user's intent and thus increases the relevance and value of the search results being returned to the user. This is done both in real-time depending on current supply and demand, but also over time through seasonality and growth or decline in particular markets. Since current search systems literally processes billions of unique user queries, the present invention's ability to aggregate user characteristics with their experiences including demographic data, online clicking and surfing behavior as well as purchase/not-purchase information enables a multi-dimensional matching technology for improved targeting of advertisements.

One of the benefits of a multi-dimensional offer exchange system, such as provided by embodiments of the present invention, over the current art of line ad search engine marketing is the ability to transition large numbers of offline advertisers into online advertisers with minimal effort required from the advertiser because existing data for each advertiser's preferred target(s) and timing are already known based upon their previous offline activities. The necessity for the advertiser to understand and manage their own online and search engine marketing flights is reduced and thus the scale at which such advertisers can be added as new participants in the operator's marketplace is increased. As the number of competing advertisers increases, the liquidity and efficiency of the marketplace also increases.

Instead of being bombarded by unwanted advertisements all of the time, the Internet is growing towards a future where both users and resources have gate-keeping software to filter and personalize their online experiences. Offer exchange, as provided by embodiments of the present invention, thus creates a natural supply center of content for such applications because it allows the creation, matching and delivery of advertisements according to any combination of multiple variables. As such, the offer exchange can also provide a direct method for the distribution of targeted advertisements to users by direct relationship with the user and not only through some aggregating affiliate traffic source such as a portal or search engine. A benefit to the marketplace operator is less volatility and better longevity because of the ability to create a direct relationship with users and no need to share any revenue that may be generated through such direct relationship with any aggregating affiliate source.

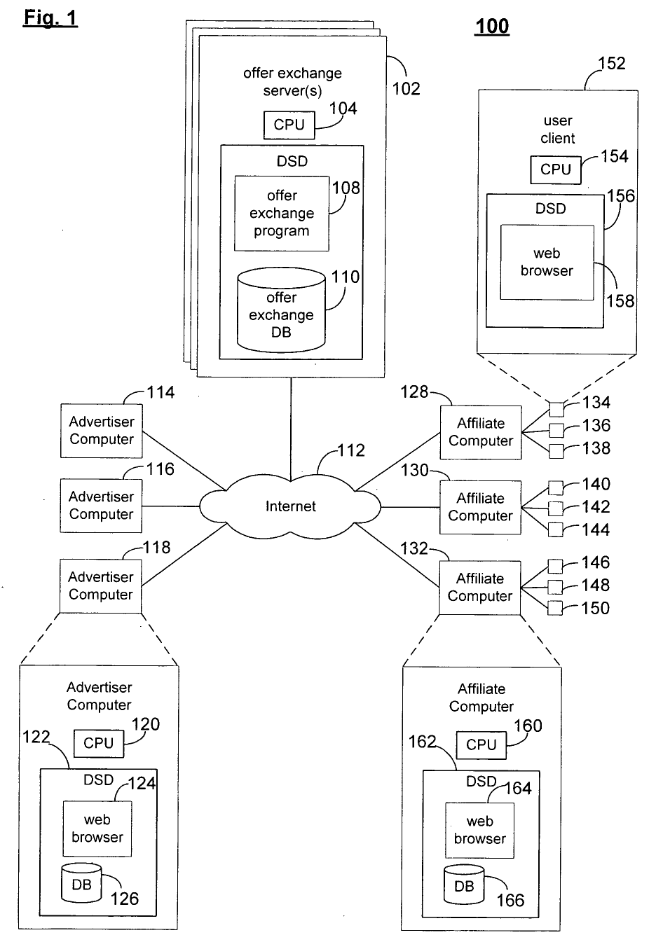

FIG. 1 is a block diagram of a distributed computer system according to one embodiment of the invention. In the computer system 100 depicted in FIG. 1, one or more offer exchange servers 102 are connected via the Internet 112 to multiple advertiser computers 114, 116, 118, and multiple affiliate computers 128, 130, 132. Each of the affiliate computers, such as the affiliate computer 128, is connected to multiple user computers, such as user computers 134, 136, 138. While the Internet 112 is depicted, the network connecting the computers can broadly include any of, or an array of, networks or distributed computer systems, which can include wired or wireless networks, public networks, private networks, secure or unsecured networks, cellular telephone networks, one or more local area networks, one or more wide area networks, peer-to-peer networks or systems, and embodiments of the invention are contemplated in which no connection to the Internet is included. In the embodiment depicted, the affiliate computers 128, 130, 132 are advertisee computers affiliated with a marketplace operator, the offer exchange servers 102 being associated with or owned by the marketplace operator.

Each of the computers 102, 114, 116, 118, 128, 130, 132, 134, 136, 138, 140, 142, 144, 146, 148, 150 comprises one or more Central Processing Units (CPUs) 104, 154, 120, and one or more data storage devices 106, 122, 156, 162 which may include one or more network or Internet Browser programs 124, 158, 164.

The data storage device 106 of the offer exchange server 102 comprises an offer exchange program 106 and one or more offer exchange databases 110, which can be relational database or other types of databases. While, as depicted, the offer exchange database 110 is located within the offer exchange server 102, the invention contemplates embodiments in which the offer exchange database 110 is located completely or partially exterior to the offer exchange server 102, and embodiments in which the offer exchange database 110 is distributed among multiple data stores and locations.

The data storage devices 106, 122, 156, 162 may comprise various amounts of RAM for storing computer programs and other data. In addition, all depicted computers may include other components typically found in computers, including one or more output devices such as monitors, other fixed or removable data storage devices such as hard disks, floppy disk drives and CD-ROM drives, and one or more input devices, such as keyboards, mouse pointing devices, or other pointing or selecting devices.

Generally, all depicted computers operate under and execute computer programs under the control of an operating system, such as Windows, Macintosh, UNIX, etc. The offer exchange program 108 broadly represents all programming, applications, software, engines, modules, or other programming-related tools used to facilitate implementing the methods of the invention as described herein.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

It is to be understood that, all depicted computers can, in other embodiments, be computerized devices, such as portable or wireless computerized devices.

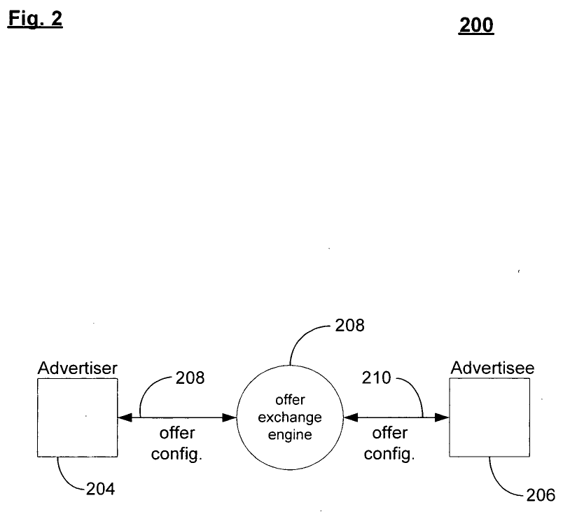

FIG. 2 is a conceptual block diagram 200 depicting offer configuration, according to one embodiment of the invention. Depicted are an offer exchange engine 202, an advertiser 204, and an advertisee 206. The offer exchange engine 202 can be provided by the offer exchange server 102 depicted in FIG. 1, and represents in abstract the programming that enables the various functionality as described herein and associated with facilitating transactions between advertisers and advertisees, including obtaining offers, user context information, and other information, matching offers and user contexts, and facilitating arranging for presentation of advertisements to users.

In the embodiment depicted in FIG. 2, both the advertiser 204 and the advertisee 206, in conjunction with the offer exchange engine 202, configure advertising-related offers. This can include both the advertiser 204 specifying conditions, including user context conditions, price conditions, etc., that the advertiser 204 or advertisee 206 require in order to agree to allow a transaction to proceed and an advertisement to be presented to a particular user or group of users. “User context”, as used herein, can include any information of any type about or obtained based on information about a user or the user's past or present behavior or conduct, which can be with explicit or implicit user consent where required, including, for example, present or historical facts about the user or the user's conduct, synthesized or calculated information based on obtained information about the user or the user's conduct, information about the user's present or past behavior or usage, or behavior or usage patterns, including present or past usage by the user of a computer or computerized device, information regarding the user's demonstrated or determined susceptibility to particular types of advertisements, and other information. “User context” can include any information about a user's environment or situation or other information associated with the user, including, for example, information regarding the user's computer, the user's demographic characteristics such as age, sex, interests, affiliations, etc., the user's being logged in to a Web service or visiting a Web site or Web page, and other information. Offer configuration can take various forms including offer definition, offer specification, offer selection, and selected offer modification, as discussed in more detail with respect to later figures.

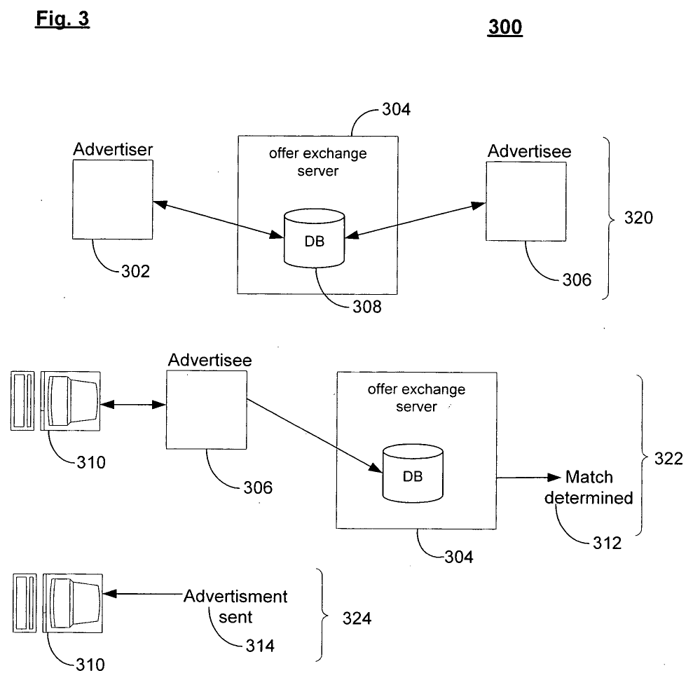

FIG. 3 is a conceptual block diagram depicting a method 300 according to one embodiment of the invention. FIG. 3 is divided into sections 320, 322, and 324. The section 320 depicts communication between an advertiser 302 and an offer exchange server 304, and between an advertises 306 and the offer exchange server 304. Information, including offers, is communicated to the offer exchange server 304 and stored in an offer exchange database 308. Communicated and stored information can also include, for example, historical or other user information relating, for example, to users who use a Web site or Web facility provided by the advertisee 306, or collected user history or other information provided by the advertiser, and other information. Section 322 depicts a user computer station 310 through which a user is communicating with the advertisee 306, such as through an advertisee Web server. The advertisee 306 transmits information, including real-time or near real time user context information, to the offer exchange server 304, which is stored in the offer exchange database 308.

Using advertiser offer information, advertisee offer information, and user context information, the offer exchange server 304 attempts to match or find compatible terms of an advertiser offer, advertisee offer, and a user context in connection with the use at computer station 310. The user context information can include real-time or almost real time information regarding the user or present use at the computer station 310, and can further include historical information regarding the user or the user's past usage or behavior which can have been transmitted from one or more advertisers or advertisees to the offer exchange server 304 and stored in the offer exchange database 308, and can include other information.

In some embodiments, rather than a simple matching process in which offers must have identical corresponding terms or dimensions, a more complex technique may be employed to determine whether offers correspond sufficiently to be joined or paired. For example, in some embodiments, a match between one or more dimensions of offers may be considered sufficient for a joining or pairing of offers, even if one or more other dimensions of the offers, or one of them, do not match or correspond. Additionally, in some embodiments or situations, offers may be joined or paired even if specified dimensions are not identical, but come within a specified degree of closeness to each other.

Furthermore, in some embodiments, the offer exchange server 304 can use probabilistic methods in performing matching, joining, or pairing functions. For example, in some embodiments, if the offer exchange server 304 can determine with a degree of probability, or closeness as measured in some way, considered sufficient, such as, for example, 70%, that a match exists, or that a particular aspect of a match or particular condition is met, then such a probability is considered sufficient to find the respective match to be found or requirement to be met. For example, if an offer requires that a user be male, and user context information demonstrates or can be analyzed or assessed to indicate that there is a 75% chance that the associated user is male, then a match of that condition can be found. In some embodiments, one or more data mining, artificial intelligence, or stochastic programs can be utilized in such probabilistic assessments and determinations. The degree of probability necessary to make a match can be controlled by the advertiser, advertisee or the marketplace operator, for example. Additionally, in some embodiments and situations, offer may be joined or paired if one or more dimensions of offers match (or a sufficient indication of closeness or percentage of a match exists, for example). As depicted in section 324, if a match is found or determined to exist, the offer exchange server 304 facilitates arranging for an advertisement to be transmitted or sent 314, which can, in some embodiments, include the offer exchange server 304 causing an advertisement to be transmitted for presentation at the computer of the user at the computer station 310.

In the manner depicted with reference to FIG. 3, an advertisement can be transmitted to a user such that the characteristics or historical information regarding the user or usage by the user, or both, or other information, is determined to meet requirements or conditions of the offers of the advertiser and advertisee, as well as, in some embodiments, conditions applied by the offer exchange server 304. In this manner, the advertisement can be highly selectively targeted to an appropriate user, or at an appropriate time, or to be presented in an appropriate fashion, so as to be likely to be noticed, considered, relevant or interesting to, or acted upon by the user.

While FIG. 3 depicts a user computer station 310, it is to be understood that the invention contemplates other embodiments, including wireless or partly wireless embodiments, in which the user is a user of, for example, a computerized cellular telephone, a notebook computers, or a handheld or other portable or partially portable computerized device including electronic billboards, elevators, cars, etc.

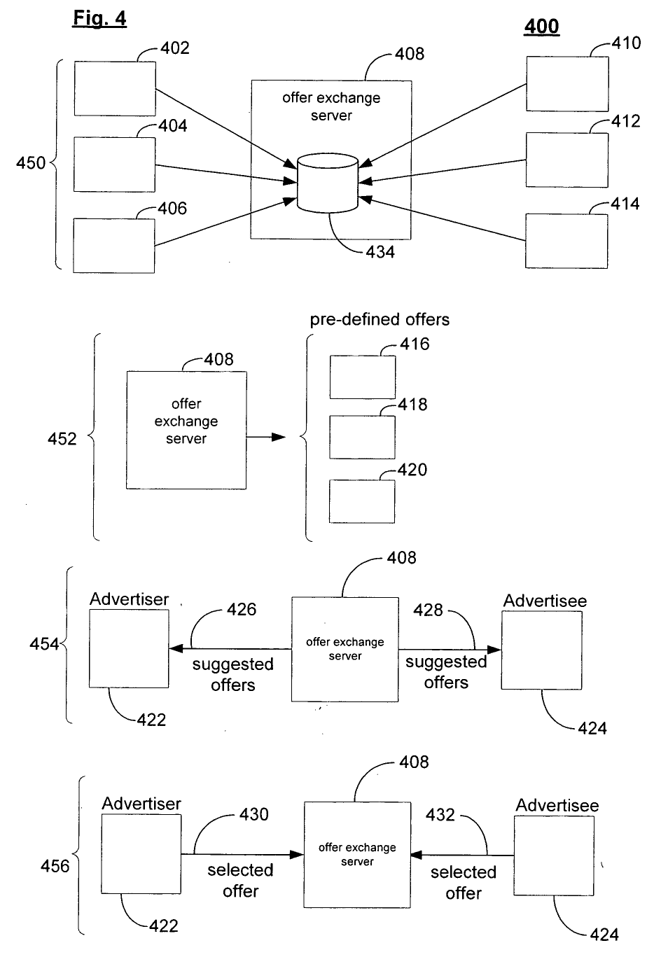

FIG. 4 is a conceptual block diagram depicting a method 400 according to another embodiment of the invention, and is divided into sections 450, 452, 454, and 456. Section 450 represents information, including historical user information and other information relevant to targeting advertisements, being communicated from numerous advertisers 402, 404, 406, and advertisees 410, 412, 414 to an offer exchange server 408 and stored in an offer exchange database 434.

Section 452 depicts the offer exchange server 408 utilizing the communicated information in the generation of pre-defined offers 416, 418, 420. Pre-defined offers can include, for example, sets of parameters or dimensions, including user context dimensions, determined, by use of the communicated information or other information or both, to be appropriate for particular categories of advertisers, advertisees, or advertisements. In some embodiments, one or more data mining programs, such as, or one or more artificial intelligence programs, or both, are used in analyzing the communicated information and determining the pre-defined offers and categories. Examples of the data mining software that can be utilized by some embodiments of the invention include the INTELLIGENT MINER software, including the IBM DB2 INTELLIGENT MINER FOR DATA, available from International Business Machines, the MINESET™ software available from SGI™, and various data mining software available from SPSS®. Additionally, in some embodiments of the invention, data mining programs, artificial intelligence programs, or both, can be used in matching offers and user contexts.

At section 454, suggested pre-defined offers are communicated by the offer exchange server 408 to the advertiser 422 and the advertises 424, such as, for example, according to categories into which the advertiser 422, the advertisee 424, or an advertisement of the advertiser 422 fall. For example, suggested offers can include user context dimensions considered or determined to indicate that associated users or usages are well-disposed to receive advertisements from the category or advertisers into which the advertiser 422 falls, or to receive advertisements through the category of advertisees into which the advertisee 424 falls.

At section 456, the advertiser 422 and the advertisee 424 select a suggested offers and communicate them to the offer exchange server 408. In some embodiments, selection can include configuration or modification by the advertiser 422 or advertisee 424.

The method 400 depicted represents a way to allow advertisers 422 and advertisees 424 to take advantage of the stored data and analysis performed by the offer exchange server 408 to select pre-defined offers that may closely match their needs, without the need to determine appropriate dimensions for themselves, and then to define an offer from scratch, identifying every dimension thereof.

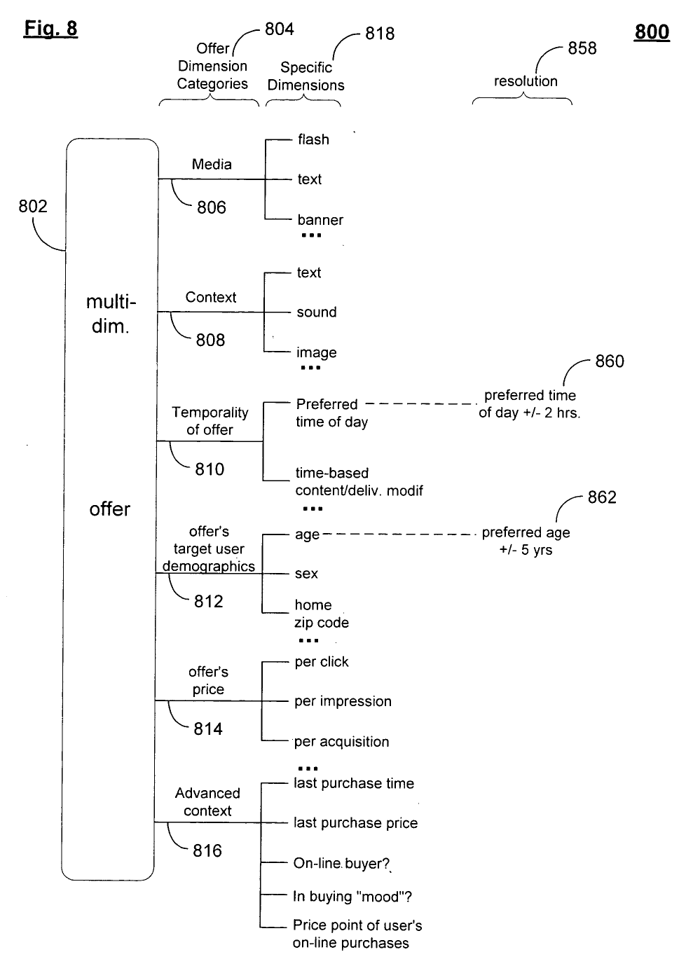

It is to be noted that, herein, specifying or determining dimensions can include specifying resolutions associated with dimensions, as described with reference to FIG. 8.

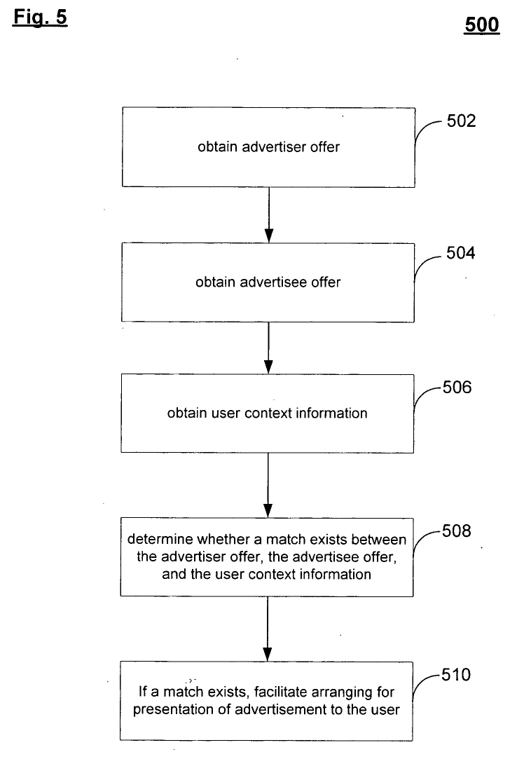

FIG. 5 is a flow diagram depicting a method 500 according to one embodiment of the invention. At step 502, an offer exchange server, utilizing an offer exchange engine, obtains an advertiser offer, including one or more user context conditions.

At step 504, the offer exchange server obtains an advertisee offer, including one or more user context conditions.

At step 506, the offer exchange server obtains user context information, which can include real-time or almost real-time information about an online user, about the online user's usage or history, or other information.

At step 508, the offer exchange server determines whether a match exists between the obtained advertiser offer, the obtained advertisee offer, and the obtained user context information.

At step 510, if a match exists or is determined to exist, the offer exchange server facilitates arranging for presentation of an advertisement, which can be specified in one or both of the obtained offers, to the online user. Arranging for presentation of the advertisement can take a number of forms, including actually transmitting the advertisement, or sending an instruction or permission for the advertiser or another entity to transmit the advertisement. In some embodiments, the type or prominence of presentation on an end display, for example, may be determined at least in part based on the degree of closeness of the match. For example, better or closer matches may lead to more prominent presentation or display, such as presentation as the first of several advertisements on an end display, and less close matches may lead to less prominent presentation or display.

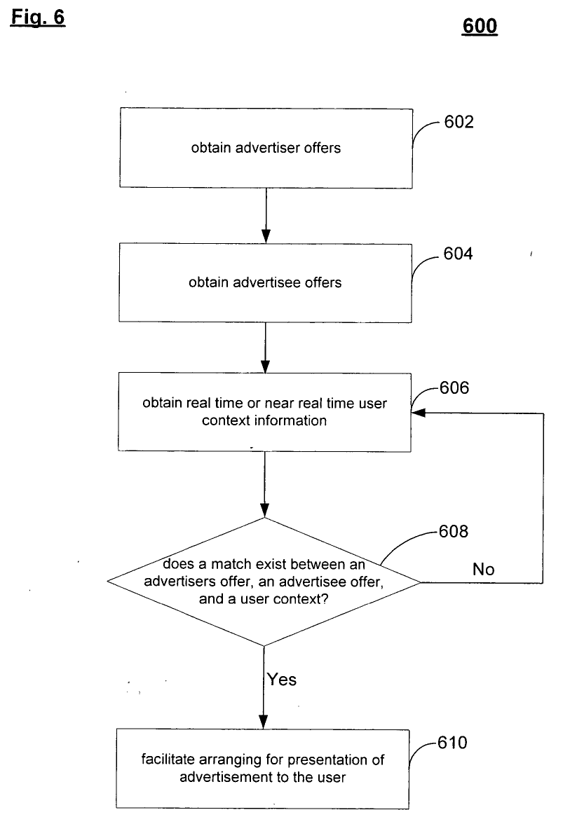

FIG. 6 is a flow diagram depicting a method 600 according to another embodiment of the invention. At step 602, an offer exchange server, using an offer exchange engine, obtains numerous offers from numerous advertisers, and stores the offers in an offer exchange database.

At step 604, an offer exchange server obtains numerous offers from numerous advertisees, such as affiliates of a marketplace operator, and stores the offers in the offer exchange database.

At step 606, the offer exchange server obtains real-time or almost real-time user context information about on online user or the online user's usage.

At step 608, the offer exchange server determines whether a match exists between an obtained advertiser offer, and obtained advertisee offer, and an obtained user context. For example, in some embodiments, the offer exchange engine is configured to be alerted when user context information is obtained that matches an offer, prompting obtaining an appropriate opposing offer, and an appropriate matching determination. If no match is found, the method 600 returns to step 606, where a new, updated, current, or additional set of user context information is obtained.

If a match does exist, the offer exchange server facilitates arranging for presentation of an advertisement to the user associated with the matching user context information.

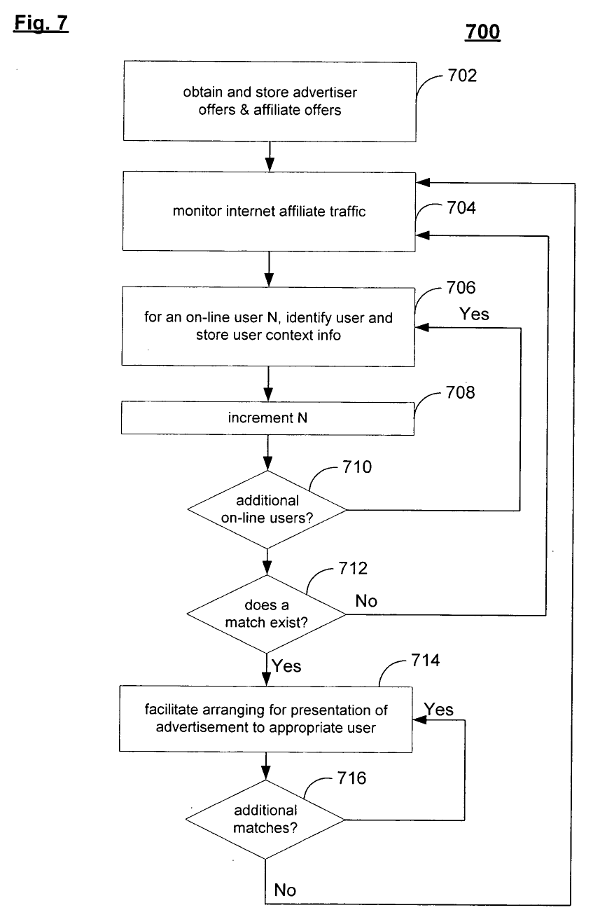

FIG. 7 is a flow diagram depicting a method 700 according to another embodiment of the invention. At step 702, an offer exchange server, using an offer exchange engine, obtains and stores in an offer exchange database advertiser and affiliate advertisee offers.

At step 704, the offer exchange engine monitors Internet traffic associated with the affiliate, such as online users at a Web page of the affiliates Web site, service, or facility.

At step 706, for an online user N, the offer exchange server identifies the user and stores associated user context information, which can include querying and utilizing information of or provided by the affiliate. It is noted that, in many instances, users of Web-based services must agree to have information about them collected by the Web-based service provider and used or communicated to other entities for advertising purposes.

At step 708, N is incremented upward by one, indicating that the offer exchange server is ready to proceed to a different online user.

At step 710, the offer exchange server determines whether another online user is present. If so, the method 700 returns to step 706, where user identification and user context information occurs for a different online user. If not, indicating that all online users are accounted for, the method 700 proceeds to step 712.

At step 712, the offer exchange server compares terms of an advertiser offer, and advertisee offer, and a set of user context information to determine whether a match exists. If not, the method 700 returns to step 704 to monitor affiliate traffic. If a match does exist, at step 714, the offer exchange server facilitates arranging for presentation of an advertisement to a user associated with the matched user context information.

Step 716 represents the offer exchange server determines whether additional matches exist. If so, the method returns to step 714 for that match. If no additional matches are found, the method 700 returns to step 704, where affiliate traffic is monitored.

FIG. 8 is a conceptual block diagram 800 depicting components of a multi-dimensional offer 802, which can be, for example, an advertiser offer or an advertises offer, according to one embodiment of the invention. The offer 802 includes offer dimension categories 804 and specific dimensions 818 associated with the categories 804.

A media category 806 relates to a technical offer delivery mechanism, independent of the destination of the offer. The media category 806 can include dimensions, for example, relating to flash, text advertisement, or banner.

A content category 808 relates to the content of an advertisement associated with the offer, and can include dimensions relating to text, image, or sound.

A temporality of the offer category 810 can be present if the advertisement is targeted to a particular time, such as time of day, day of the week, etc. Temporal dimensions can relate to a preferred time of day to present an advertisement, or content or delivery modifications to the advertisement depending on the time of presentation.

An offer's target user demographics category 812 can include dimensions relating to any of various user parameters including, for example, age, sex, marital status, Zip code, country of citizenship, country of birth, salary, and geographic present or residential location.

An offer's price category 814 relates to what an advertiser is willing to pay, or what an advertisee is willing to accept as payment, for having an advertisement shown, or showing an advertisement. Dimensions of this category can relate to price to pay for a user's click (or other selection action), price to pay per user impression, or price to pay for a user acquisition or conversion.

An advanced context category represents dimensions that are mined, analytically determined, or otherwise calculated, on a continual or periodic real-time basis or almost real-time basis, or otherwise. In some embodiments, one or more data mining or artificial intelligence programs are used in determining dimensions of this category. Example dimensions of this category can relate to, for a particular user, a last purchase time frame or price, whether or to what extent the user is or has historically been an online buyer or in a buying mood, and a price point for the user's online purchases.

In some embodiments, resolutions, such as depicted resolutions 858, can be specified for some or all dimensions. Resolutions can specify a range, set, or variance from a specified point or value that is considered to satisfy a specified dimension condition. For example, as depicted, with respect to a dimension relating to a preferred time of day for presentation of an advertisement 832, an associated resolution 860 can specify an acceptable time range about or otherwise included a preferred time, such as a preferred time plus or minus a maximum of two hours. As an additional example, a resolution 862 associated with an age dimension could specify a preferred user age plus or minus a maximum of five years. Other examples of resolutions can include geographic resolutions such as a maximum distance from a specified geocode, and a search-term related resolution such as a semantic distance of a search phrase from a bidded phrase.

In addition to the above, in some embodiments, an offer exchange engine can use catalyzers or factors to facilitate matching by, for example, affecting, modifying, or weighting aspects of dimensions of offers to facilitate appropriate or desirable matching, using one or more data mining programs, one or more artificial intelligence programs, or otherwise. Catalyzers can include, for example, factors relating to: a quality rating of an advertiser or an advertisee site; a buy-readiness factor that may be mined from historical user behavior or click patterns that may indicate that a particular user is a likely acquisition candidate and therefore more valuable than a user who is average or typical in this regard; behavioral demand, such as an indication of prior Web pages visited and prior purchases made by a user; an indication of a time-related demand, such as, for example, a demand for a 9 am to 5 pm advertisement slot; an indication of demographic demand, such as, for example, a desire to target males between ages 18-25; and any union or intersection, for example, of the previously listed factors, resulting in the creation of meta-demands.

As previously described with reference to FIG. 4, in some embodiments, an offer exchange engine can be used to generate pre-defined offers or offer types. In some embodiments, an offer exchange engine can include offering up to advertisers or advertisees pre-defined offers, or offers with pre-defined sets of dimensions, which can include search term or term-based concept related dimensions. In some embodiments, the offer exchange engine can facilitate bidding or auctions in such offers, including participation of advertisers or advertisees, and can provide, in this or other ways, virtual marketplaces in offers. Auctions can include any type of auction including blind, reverse dutch, etc.

In some embodiments, an offer exchange server can determine and utilize, or make available for utilization by entities such as advertisers or advertisees, demands by users with respect to particular advertisement types or channels, such as for example, demand relating to user viewing, selection, activity, or interest associated with browsing style interaction (which can be termed “contextual demand”), demand associated with user typing (which can be termed “search demand”), yellow page-style local product context interface (which can be termed “local demand”).

Although, in some embodiments, both an advertiser offer and an advertisee offer must be specified or matched, it is to be understood that, in some embodiments, an advertiser offer can be defined in terms of, with reference to, or as being identical with, and advertisee offer, or vice-versa, whether explicitly or implicitly.

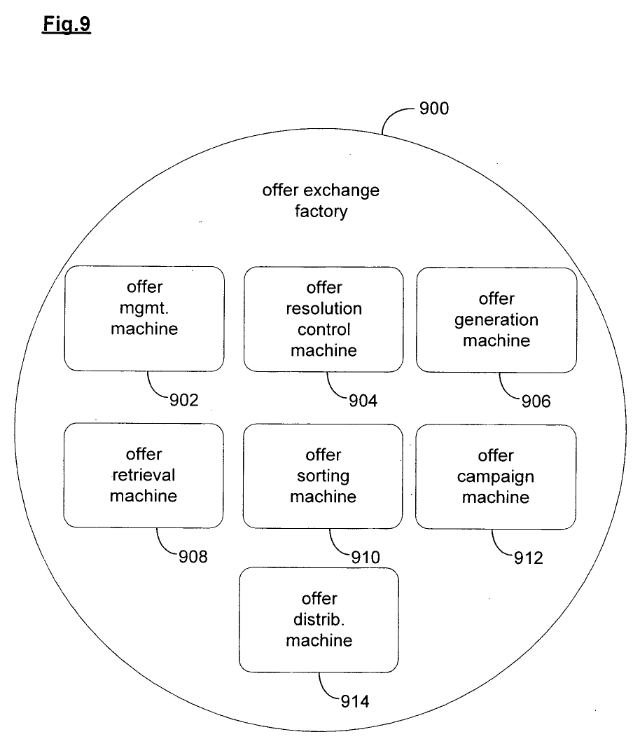

FIG. 9 is a conceptual block diagram 900 depicting components of an offer exchange factory 900, according to one embodiment of the invention. In some embodiments, an offer exchange factory, which can be a form of offer exchange engine, is a complex, modular software or programming system used to facilitate functions to enable or enhance various functions. Such functions can include offer management, matching, demand resolution, offer sorting, performance tuning by demand aggregation, automatic tuning qualification along various dimensions and budgets based on performance objectives, and other functions. An offer exchange factory can include a federated set of offer exchange machines. Each offer exchange machine can itself be loosely coupled federated services, or can be strong or tightly coupled services such as dynamically linked libraries, or can be a mix thereof. An offer exchange machine can be an engine, service, algorithm, data IO processing system, or combination thereof for accomplishing a particular type or category of tasks. Offer exchange machine parts can then be defined as components of a particular offer exchange machine.

In some embodiments, the offer exchange factory 900 can include various machines 902, 904, 906, 908, 910, 912, 914.

The offer management machine 902 can provide an ability to create, modify, or delete offers or dimensions thereof.

The offer resolution control machine 904 can provide an ability to modify offer-related resolutions relating to single dimensions or aggregated sets of dimensions.

The offer generation machine 906 can generate offers or dimensions of offers.

The offer retrieval machine 908 can obtain or select appropriate offers based on context, catalyzers, or other factors or inputs.

The offer sorting machine 910 can sort output from the offer retrieval machine according to specified parameters that can relate to price, CTR, resolution, advertiser willingness to pay more based on catalyzers, or other factors.

The offer campaign machine 912 can control, manage, or specify a set of offers with a common performance goal, and can adjust offer dimensions to meet particular campaign goals.

The offer distribution machine 914 can utilize the offer resolution control machine 904, the offer retrieval machine 908, and the offer sorting machine 910 to supply offers for distribution to satisfy demand, and to supply management interface to configure the distribution.

As described above, an offer exchange engine (or factory) can be used, among other things, to allow offer configuration and matching in a virtual marketplace. A virtual marketplace can include a computational or software environment in which an advertiser offer (such as, for example, a banner advertisement) is offered up for matching with a compatible advertisee offer (such as, for example, a spot on a home page for a banner advertisement). An advertisee offer can also be viewed as a demand for a compatible advertiser offer, and, in the following discussion, for simplicity, an advertiser offer will be referred to hereinafter as an “offer” and an advertisee offer will be referred to hereinafter as a “demand.” Such a marketplace is referred to as “virtual” only to highlight the fact that non-physical items can be involved, and not to suggest that the marketplace is itself not actual or real.

In such a virtual marketplace, the offers are “items” of value sought to be matched with demands for such things. As described above in detail with reference to FIG. 8 and elsewhere, offers (whether offers or demands) include parameters, or dimensions as referred to above, that define and specify the offers. Generally, in a particular virtual marketplace, offers and demands with common dimensions, or at least some common dimensions, are sought to be matched, with an offer exchange engine facilitating the matching (as well as, in some embodiments, specification of the offers and demands themselves). However, just as different types of items can be involved in different marketplaces generally, so can different virtual marketplaces exist, each virtual marketplace including or being part of an environment in which offers and demands having or sharing particular dimensions, or otherwise having compatible dimensions, are sought to be matched.

While the invention has been described above largely with reference to a single virtual marketplace, the invention contemplates embodiments in which many virtual marketplaces are run simultaneously, all facilitated by an offer exchange engine. Such a situation can be analogous in some ways to a financial exchange, which can be viewed as a group of simultaneously run marketplaces in which different types of securities (stocks, bonds, etc.) are marketed. In a virtual marketplace according to some embodiments of the present invention, many virtual marketplaces are run simultaneously, with different types “items” (i.e. offers and demands) being sough to be matched in each different marketplace. Such an environment including multiple marketplaces can be run as a unified and diverse exchange.

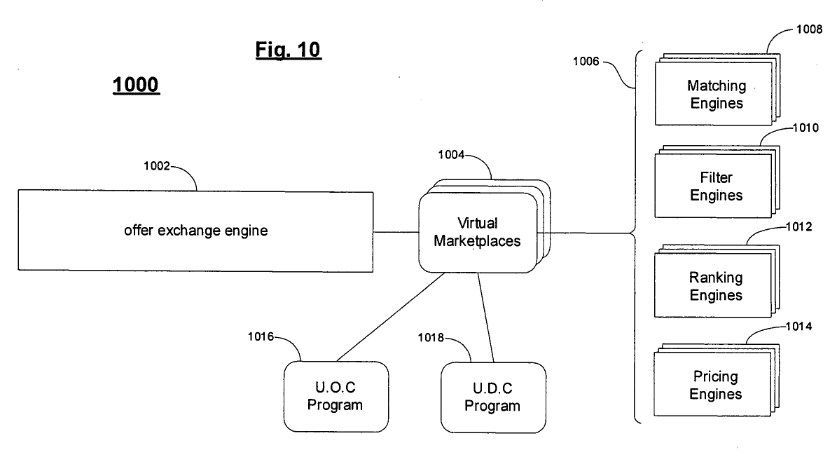

FIG. 10 is a conceptual block diagram 1000 depicting multiple virtual marketplaces 1004 and an associated offer exchange engine 1002. Also depicted are a universal offer collection program 1016 and a universal demand collection program 1018. Various engines, including a matching engine 1008, a filter engine 1010, a ranking engine 1012, and a pricing engine 1014, are used in association with the virtual marketplaces 1004, as described below.

In the embodiment depicted in FIG. 10, the multiple marketplaces 1004 are simultaneously run, facilitated by the offer exchange engine 1002. The different virtual marketplaces provide advertisers and advertisees with opportunities to market offers and demands with different sets of dimensions. A variety of marketplaces allows advertisers and advertisees to offer up different types of advertising-related products or properties, which can be advertising-related offers and demands defined by different sets of dimensions. This allows advertisers and advertisees the flexibility to choose one or more marketplaces in which the dimensions and resolutions of offers and of demands in the marketplace best suits the advertisers or advertisees needs or desires in defining or specifying their offers or demands. For example, an advertisee, such as an affiliate of a marketplace operator, can choose a marketplace in which offers include dimensions and resolutions (and possibly other characteristics) that suit the advertisee best, such as by being considered to be most likely to lead to maximum monetization or utilization of the advertisee's advertising-related properties.

In some embodiments, the virtual marketplaces 1004 are not static but are instead real-time or near real-time configurable by an advertiser, an advertisee, or a marketplace operator, for example, to optimize performance or efficiency. Additionally, some embodiments provide an exchange incorporating the various marketplaces, allowing real-time or near real time negotiation between, for example, advertisers and advertisees. While the availability of different marketplaces provides a degree of flexibility, dynamically configurable or tunable marketplaces, or of an exchange allowing negotiation between parties, provides an even greater level of flexibility. In some embodiments, for example, an affiliate that decides “on the fly” that it would be desirable to market demands of particular dimensions and resolutions, the affiliate can construct, via an Internet interface or otherwise, a virtual marketplace to suit those exact needs and maximize spot monetization of their properties. As another example, a marketplace operator may decide that a particular type of virtual marketplace will lead to the greatest profit, and can configure such a marketplace accordingly. Furthermore, changes to existing marketplaces, or tuning of marketplace configuration, can be allowed.

The engines 1008, 1010, 1012, 1014 are used to allow the affiliate, or other party, to perform such dynamic marketplace configuration or tuning. For example, in some embodiments, particular engines can be mixed and matched to configure a particular virtual marketplace. In some embodiments, for example, a particular matching engine can be used to apply particular rules to determine what constitutes a match between an offer and a demand. A filter engine can be used, for example, to apply rules to determine which offers are not to be considered for matching, such as offers containing advertisements that may be considered offensive to an affiliate providing a demand. A ranking engine can be used, for example, in a sponsored search environment to determine which offers for computerized search-related advertisements acquire which rank in displayed search results. A pricing engine can be used, for example, to apply rules to determine, based on specified factors, a price or a price adjustment that an advertiser may be willing to pay in the context of a particular offer/demand match. Generally, different engines 1008, 1010, 1012, 1014, possibly among others, can be used to define a spectrum of different marketplaces, and can also be used to help assure quality of service, including improving response time and helping maximize monetization for parties.

In an environment, such as an exchange, containing many virtual marketplaces, it can be valuable to be able to pool offers and demands for inclusion in an appropriate marketplace. For example, an affiliate offering up a demand may not know which of many marketplaces is suitable for marketing of the demand. Conversely, an advertiser may not know which marketplace is suitable for a given offer. As such, integration of marketplaces can be facilitated by pooling of offers and demands and by having appropriate offers and demands marketed in appropriate marketplaces.

In some embodiments, the universal offer collection program 1016 and the universal demand collection program 1018 provide hardware, software or other tools to collect, pool, and direct offers and demands accordingly. Such offers and demands can be stored in the offer exchange database 108 (depicted in FIG. 1), or elsewhere. Offers and demands can be annotated, and such annotations also saved in the database 108, to facilitate effective and efficient matching. By efficiently gathering and directing offers and demands across many marketplaces, universal offer and demand collection can help unify and integrate marketplaces, making each marketplace more efficient and viable, and preventing advertisers and advertisees from needing to spend time and effort researching appropriate marketplaces for offers and demands. In some embodiments, a marketplace operator can provide universal offer and demand collection services for a fee to advertisers and advertisees. Additionally, in some embodiments, the engines 1008, 1010, 1012, 1014 make use of offer and demand collection in providing virtual marketplaces and the offers and demands therein. Furthermore, data communication and replication can be provided to transfer offers and demands as needed between the database 108 and the various engines 1008, 1010, 1012, 1014.

Just as advertisers and advertisees may need or desire help in determining virtual marketplaces for their offers and demands, so may they need or desire help in performing marketplace configuration or tuning, such as real time configuration or tuning, as well as offer and demand configuration, to best and most efficiently suit their needs. In some embodiments of the invention, advertiser and advertisee tools are provided (such as by the offer exchange program 108 depicted in FIG. 1, or otherwise) to assist or guide advertisers and advertisees in configuring or tuning marketplaces, or to actually configure or tune marketplaces based on information provided by the advertisers and advertisees, as well as to assist in defining offers and demands, or actually configure such offers and demands. For example, in some embodiments, an advertiser or advertisee provides comprehensive information about what they wish to accomplish in terms of the advertising-related properties they wish to market, the prices they are willing to accept, pay, or consider, and potentially other rules or guidelines. With that information, the advertiser and advertisee tools can be used to configure offers, demands, and marketplaces, and to effectively populate universal offer and demand collection pools.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. In a networked computer system, a computerized method for facilitating a transaction between at least an advertiser and an advertisee for arranging for presentation of an advertisement to at least one user of a computerized device, the method comprising:
obtaining an advertiser offer comprising conditions including a first set of one or more user context conditions required by the advertiser for presentation of the advertisement to the user;
obtaining an advertisee offer comprising conditions including a second set of one or more user context conditions required by the advertisee for presentation of the advertisement to the user;
obtaining user context information including information relating to the first and second sets of user context conditions;
using the advertiser offer conditions, the advertisee offer conditions, and the obtained user context information, determining whether a match exists between the advertiser offer, the advertisee offer, and the user context; and
if the match exists, facilitating arranging for presentation of the advertisement to the user.

2. The method of claim 1, comprising obtaining a multi-dimensional advertiser offer and a multi-dimensional advertisee offer.

3. The method of claim 1, comprising facilitating arranging for presentation of the advertisement to an online Internet-based user.

4. A system for facilitating a transaction between at least an advertiser and an advertisee for arranging for presentation of an advertisement to at least one user of a computerized device, the system comprising:
means for obtaining an advertiser offer comprising conditions including a first set of one or more user context conditions required by the advertiser for presentation of the advertisement to the user;
means for obtaining an advertisee offer comprising conditions including a second set of one or more user context conditions required by the advertisee for presentation of the advertisement to the user;
means for obtaining user context information including information relating to the first and second sets of user context conditions;
means for using the advertiser offer conditions, the advertisee offer conditions, and the obtained user context information, determining whether a match exists between the advertiser offer, the advertisee offer, and the user context; and
means for, if the match exists, facilitating arranging for presentation of the advertisement to the user.

5. A system for facilitating a transaction between at least an advertiser and an advertisee for arranging for presentation of an advertisement to at least one user of a computerized device, the system comprising:
one or more offer exchange server computers connected to a network;
one or more offer exchange databases connected to the network and accessible by the one or more offer exchange server computers, the one or more offer exchange databases storing information comprising:
an advertiser offer comprising conditions including a first set of one or more user context conditions required by the advertiser for presentation of the advertisement to the user;
an advertisee offer comprising conditions including a second set of one or more user context conditions required by the advertisee for presentation of the advertisement to the user;
user context information including information relating to the first and second sets of user context conditions;
wherein the one or more offer exchange server computers:
using the advertiser offer conditions, the advertisee offer conditions, and the user context information, determine whether a match exists between the advertiser offer, the advertisee offer, and the user context; and
if the match exists, facilitate arranging for presentation of the advertisement to the user.

6. The system of claim 5, wherein the one or more offer exchange server computers obtain, and cause to be stored in the offer exchange database, the advertiser offer, the advertises offer, and the user context information.

7. The system of claim 5, wherein the system facilitates a plurality of transactions between advertisers and advertisees, and wherein the database contains a plurality of advertiser offers and a plurality of advertises offers, and information regarding a plurality of computer user contexts.

8. The system of claim 5, wherein the advertisement comprises at least one of text, imagery, and sound to be presented through the computerized device of the computer user.

9. The system of claim 5, wherein the advertisement facilitates sale of a product, a service, or content.

10. The system of claim 5, wherein the computerized device is selected from the group including a desktop computer, a notebook computer, a wireless computerized device, a portable computerized device, and a handheld computerized device.

11. The system of claim 5, wherein the one or more offer exchange servers are marketplace operator servers, and wherein the advertisee is an affiliate of the marketplace operator.

12. The system of claim 11, wherein the marketplace operator obtains a fee from at least one of the advertiser and the advertisee in connection with facilitating the transaction.

13. The system of claim 5, comprising:
one or more advertiser computers connected to the network;
one or more advertisee computers connected to the network; and
one or more user computerized devices connected to the network.

14. The system of claim 5, wherein the offers each comprise one or more dimensions.

15. The system of claim 5, wherein the one or more dimensions comprise resolutions.

16. The system of claim 13, wherein the offers each comprise a search term-related dimension.

17. The system of claim 13, wherein the offers each comprise a user location-related dimension.

18. The system of claim 13, wherein the user location related dimension is a real-time or almost real time physical location of the user.

19. The system of claim 14, wherein the dimensions include at least one of user context-related dimensions, media, content, demographics, and price.

20. The system of claim 19, wherein the dimensions include at least one of price per click, price per impression, and a price per user acquisition.

21. The system of claim 5, wherein determining whether a match exists comprises performing probabilistic matching.

22. The system of claim 5, comprising application of catalyzers to offers to facilitate effective offer matching.

23. The system of claim 11, wherein:
the offer exchange database comprises aggregated information useful in advertisement targeting and obtained from a plurality of affiliates;
the one or more offer exchange servers utilize the aggregated information to determine pre-defined offers considered well suited to particular categories of at least one of advertisers and advertisees; and
the one or more offer exchange servers propose pre-defined offers to at least one of advertisers and advertisees of appropriate categories for selection.

24. The system of claim 23, wherein the aggregated information comprises aggregated historical user behavior-related information.

25. The system of claim 23, wherein selected proposed pre-defined offers can be at least one of modified and at least partially configured.

26. The system of claim 25, wherein selected pre-defined offers can be partially configured by choosing at least one desired resolution of a dimension.

27. The system of claim 23, wherein the marketplace operator provides virtual marketplaces in multi-dimensional offers.

28. The system of claim 27, comprising using information stored in the database to determine dimensional ranges of values of dimensions of a pre-defined offer such that the pre-defined offer specifies at least one user context to which advertisements of a particular category are well-targeted.

29. The system of claim 5, wherein the offer exchange server comprises a offer exchange engine, and wherein the offer exchange engine comprises programming comprising a plurality of virtual offer exchange machines including at least one of an offer management machine, an offer resolution control machine, and offer retrieval machine, and offer sorting machine, an offer campaign machine, and an offer distribution machine.

30. The system of claim 5, wherein the network comprises a wireless network, and comprising wireless transmission of the advertisement to the user.

31. The system of claim 5, comprising generating the pre-defined offers, and wherein at least one of matching, generating pre-defined offers, and comprising directing pre-defined offers utilizing at least one of one of a data mining program and an artificial intelligence program.

32. The system of claim 5, comprising, in matching, comparing stored offers with user context information as such user context information is obtained.

33. A computer usable medium or media storing program code which, when executed on one or more computerized devices, causes the computerized devices to execute a computerized method for facilitating a transaction between at least an advertiser and an advertisee for arranging for presentation of an advertisement to at least one user of a computerized media outlet of the advertisee, the method comprising:
obtaining an advertiser offer comprising a first set of one or more user context conditions required by the advertiser for presentation of the advertisement to the user;
obtaining an advertisee offer comprising a second set of one or more user context conditions required by the advertisee for presentation of the advertisement to the user;
obtaining user context information including information relating to the first and second sets of user context conditions;
using the obtained user context information, determining whether the user context satisfies the first and second sets of user context conditions; and
if the user context satisfies the first and second sets of conditions, facilitating arranging for presentation of the advertisement to the user on a real-time of almost real-time basis.
